(19) United States
(12) Patent Application Publication
(10) Pub. No.: US 2008/0005942 A1
(43) Pub. Date: Jan. 10, 2008

(54) Resilient portable sign

(75) Inventor: Donald Harney, Woodward, IA (US)

Correspondence Address: BRETT J. TROUT, PC, 516 WALNUT, DES MOINES, IA, 50309, US

(73) Assignee: Regency Innovations, LLC

(21) Appl. No.: 11/483,211

(22) Filed: Jul. 7, 2006

(51) Int. Cl. G09F 11/18

(52) U.S. Cl. 40/518

(57) ABSTRACT

An improved sign is provided with a pair of rollers secured to opposite ends of a display surface. A first roller is provided within a first tube formed in one side of the display surface, and a second roller is provided in a tube formed on an opposite side of the display surface. A pair of handles are journaled to the rollers and the display surface is constructed in a manner which biases the display surface toward a curled orientation around the tubes. When the handles are pulled apart from one another, the sign unfurls and the message is displayed. When the handles are released, the bias of the display surface toward the curled orientation causes the rollers to move toward one another as the sign curls back around the rollers into a compact configuration for transportation or storage.

### BACKGROUND OF THE INVENTION

1. Field of the Invention

The present invention relates in general to a portable sign for displaying a communication and, more particularly, to an improved portable sign which is of a lightweight, low cost manufacture and which expands to a large size to allow communications to be seen over a great distance.

2. Description of the Prior Art

It is known in the art to provide signage at sporting events and the like to allow fans to display messages in support of their team, disagreement with an officiating call, communicate with fans of the opposing team, etc. While it is known in the art to provide such signs out of paper, such signs are easily wrinkled and difficult to transport without damage. Although smaller signs may be constructed, they are more difficult to see. An additional drawback associated with paper signs is their inability to resist damage from high winds and rain.

It is also known in the art to provide signs constructed of cardboard. While cardboard is stronger than paper, and may be coated with plastic to resist the elements, cardboard signs are much bulkier than paper signs and, therefore, much more difficult to transport.

It is also known in the art to provide plastic signs, and signs made out of cloth or other textiles. One drawback associated with such prior art signs is the inability to quickly transform these signs from a smaller, more compact orientation for transport and a larger, flatter orientation more suitable for communication.

It would, therefore, be desirable to provide a small, compact, weather resistant sign which may be quickly and readily transformed from a small, compact orientation suitable for transport to a large flat orientation suitable for communication of the message provided on the sign. The difficulties encountered in the prior art discussed hereinabove are substantially eliminated by the present invention.

### SUMMARY OF THE INVENTION

In an advantage provided by this invention, an improved sign is provided which is of a low cost manufacture.

Advantageously, this invention provides an improved sign which is lightweight.

Advantageously, this invention provides an improved sign which is weather resistant.

Advantageously, this invention provides an improved sign which allows for rapid deployment to and from a transport configuration.

Advantageously, in a preferred example of this invention, an improved sign is provided. The sign is provided with a display surface constructed of a resilient material biased toward a curled orientation. A communication is provided on the display surface. The display surface is provided around a spool and means are provided for unfurling the display from the spool sufficiently to allow the communication on the display surface to be read, and for releasing the display surface to allow the display surface to wind around the spool. In the preferred embodiment, the sign is a curled polyethylene terephthalate sheet which may be aluminized and which is wrapped on either end around a spool. The spools are preferably coupled to handles which allow the spools to be quickly moved apart from and toward one another, to allow the communication on the display surface to be read as the handles are pulled apart, and which allows the polyethylene terephthalate sheet to curl around the spools as the handles are moved toward one another.

### BRIEF DESCRIPTION OF THE DRAWINGS

The present invention will now be described, by way of example, with reference to the accompanying drawings in which:

FIG. 1 illustrates an exploded perspective view of the improved sign of the present invention;

FIG. 2 illustrates a top plan view of the improved sign of the present invention fully unfurled;

FIG. 3 illustrates a side elevation of the improved sign of the present invention filly unfurled;

FIG. 4 illustrates a side elevation of the improved sign of FIG. 3 shown from the opposite side;

FIG. 5 illustrates a front perspective view of an alternative embodiment of the improved sign of the present invention; and

FIG. 6 illustrates a side elevation of another alternative embodiment of the improved sign of the present invention.

### DETAILED DESCRIPTION OF THE PREFERRED EMBODIMENT

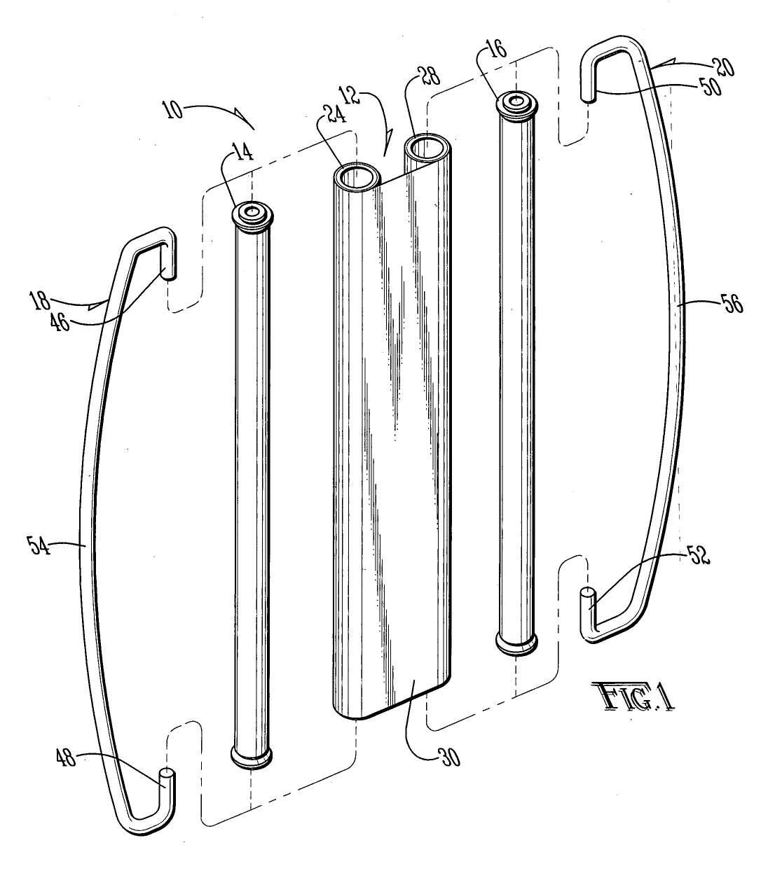

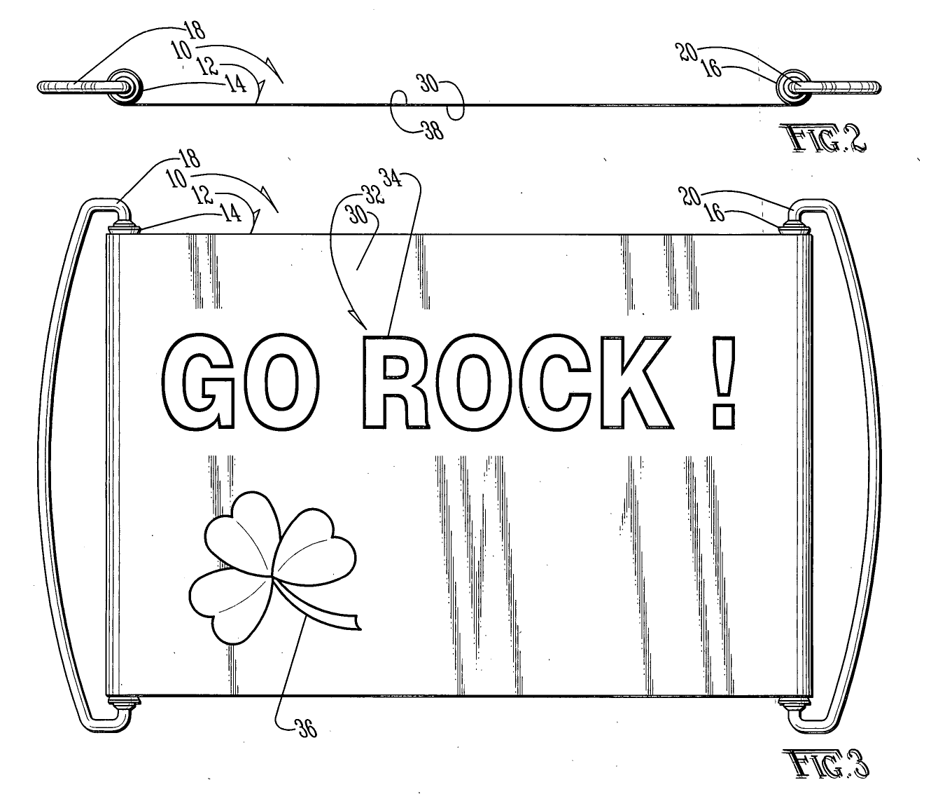

An improved sign according to the present invention is shown generally as (10) in FIG. 1. The sign (10) includes a display surface (12), a first roller (14), a second roller (16), a first handle (18) and a second handle (20). As shown in FIG. 2, the display surface (12) includes a flat sheet of material, such as aluminized biaxially-oriented polyethylene terephthalete polyester film. Alternatively, any type of material such as metal, plastic, rubber, paper or other material which can be designed to resiliently bias toward a curled configuration may be utilized. If desired, the material may be coated with a polyester or wax to reduce friction as the display surface curls.

As shown in FIG. 2, the display surface (12) is provided with a first end (22), which is curled around and secured back on to the display surface (12) with an adhesive, heat forming or similar securement means to form a first tube (24). Preferably, the first tube (24) is provided with a diameter slightly larger than the diameter of the first roller (14). Similarly, the display surface (12) is provided with a second end (26), curled around and secured to the display surface (12) by adhesive, heat forming or similar securement means to form a second tube (28), having a diameter slightly greater than the diameter of the second roller (16). The display surface (12) may be of any suitable size or configuration. In the preferred embodiment, the display surface (12) is rectangular, the display surface (12) may, of course, be triangular or of any suitable configuration. Additionally, the surface area of the display surface (12) is preferably between one square centimeter and five square meters, more preferably between one-hundred square centimeters and two square meters, and, most preferably, between .05 square meters and .5 square meters.

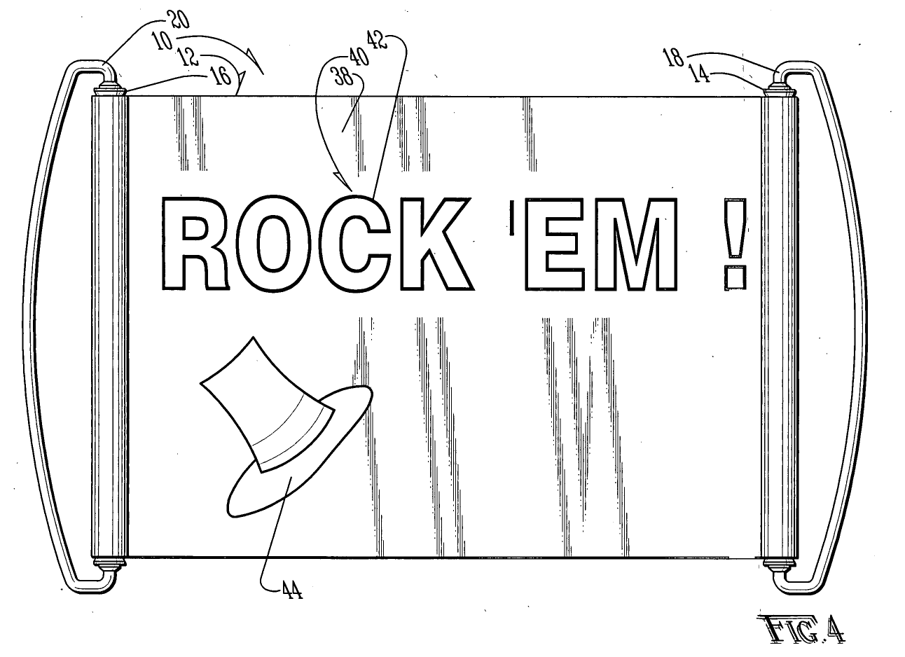

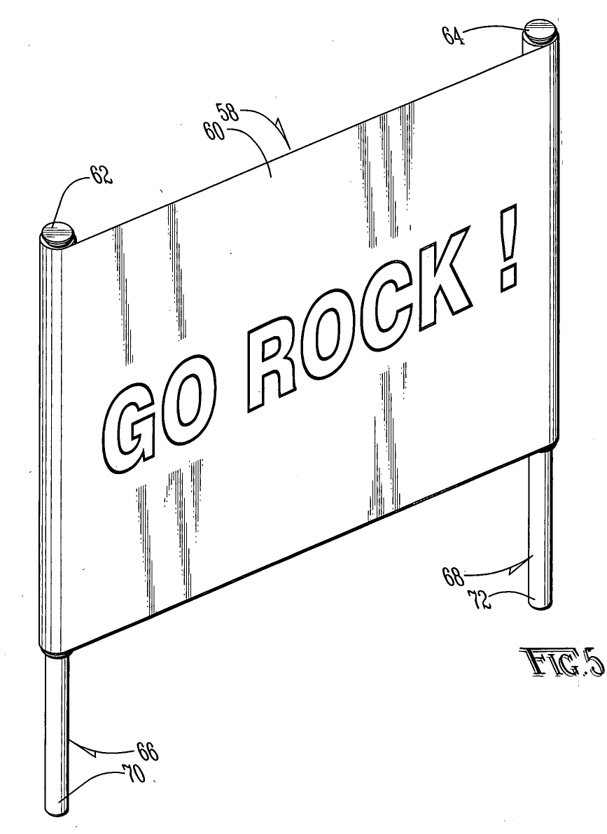

As shown in FIG. 3, the display surface (12) is preferably provided on a first side (30) with a first communication (32) such as a first text message (34) and a first team symbol (36). As shown in FIG. 4, the display surface (12) is provided with a second side (38), provided with a second communication (40), including a second text message (42) and a second team symbol (44). The communications (33) and (40) may, of course, be numbers, letters, flags, symbols, colors, or may simply be a single color to allow a plurality of users to alternate displaying sides (30) and (38) of the sign (10) above their heads to form a much larger pixilated message as the result of a large crowd selectively showing either the first side (30) or second side (38) of the sign (10) to provide the desired pixilation for the intended message. Additionally, the communications (32) and (40) may be permanent, may be provided on the first side (30) and second side (38) by the user, may be erasable, and may also be letters, numbers or symbols removably applied to the display surface (12).

As shown in FIGS. 1-2, when it is desired to utilize the sign (10) of the present invention, the display surface (12) is constructed with the first tube (24) and second tube (28), and manufactured to resiliently bias toward a curled orientation, such as that shown in FIG. 1. Preferably, the tubes (24) and (28) are provided in a manner which bends the portion of the display surface (12) forming the tubes (24) and (28) in the opposite direction of the biased curl, so as to force the tubes (24) and (28) sufficient to receive the rollers (14) and (16). Preferably, the rollers (14) and (16) are constructed of hollow plastic tube of a length equal to the height of the display surface (12). While the rollers (14) and (16) may be of any desired diameter, in the preferred embodiment the rollers are preferably between one-half centimeter and five centimeters in diameter, and most preferably about one-half centimeter in diameter, with a wall thickness of approximately two millimeters. Once the rollers (14) and (16) have been provided within the tubes (24) and (28) formed in the display surface (12), the handles (18) and (20) are secured within the rollers (14) and (16). As shown in FIG. 1, the handles (18) and (20) are provided with fingers which extend into the first roller (14) and second roller (16). Preferably, the handles (18) and (20) are of a solid construction, but are constructed of the same material as the rollers (14) and (16). Preferably, the rollers (14) and (16), and handles (18) and (20), are constructed of an inexpensive, lightweight resilient plastic material but may, of course, be constructed of metal, cardboard, wood or any other suitable material.

As shown in FIG. 1, the fingers (46), (48), (50) and (52) are coupled to risers (54) and (56), which allow the handles (18) and (20) to be grasp and pulled in opposite directions by the user. In the preferred embodiment, the risers (54) and (56) are angled to cause the fingers (46), (48), (50) and (52) to move deeper into the rollers (14) and (16) when the risers (54) and (56) are pulled. The handles (18) and (20) may be constructed of any desired configuration. Additionally, if desired, the length of the two lower fingers (48) and (52) may be extended to the entire length of, or just short of the entire length, the rollers (14) and (16), and the top one-half of the handles (18) and (20) removed. This would allow the sign (10) to be actuated with only a single journal point between the first handle (18) and first roller (14) and second handle (20) and second roller (16).

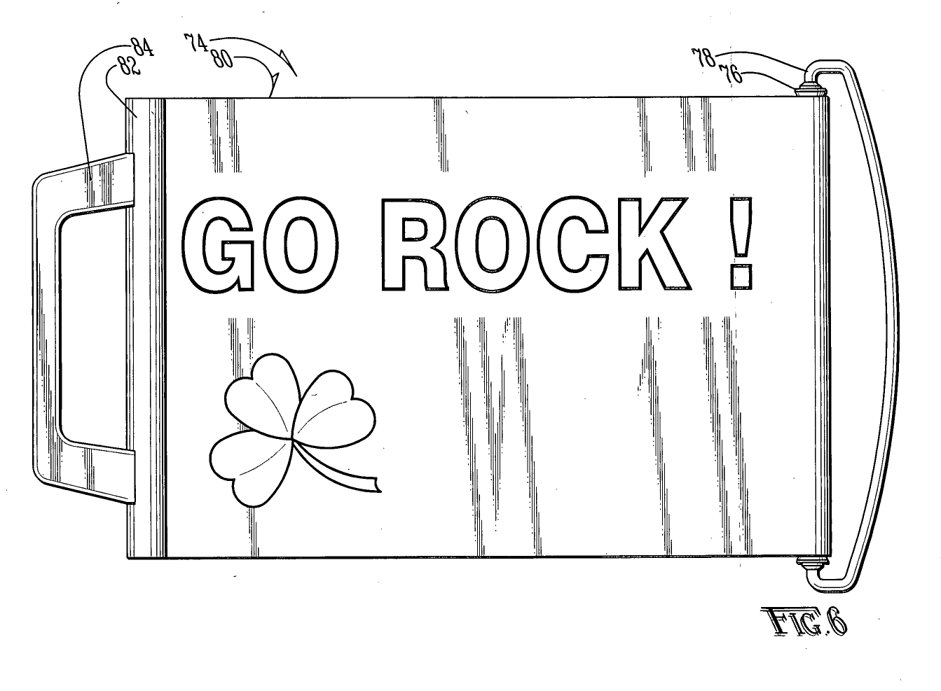

FIG. 5 illustrates an alternative embodiment of the sign (58). As shown, the sign (58) includes a display surface (60), a first roller (62) and second roller (64) configured as described above. The sign (58) is also provided with handles (66) and (68) which are slidably received within the rollers (62) and (64). The handles (66) and (68) can be stored within the rollers (62) and (64), and retained therein by detents (not shown) or any other means known in the art. Preferably, when the handles (66) and (68) are retained within the rollers (62) and (64), the ends (70) and (72) of the handles (66) and (68) extend from the rollers (62) and (64). When it is desired to reveal the display surface (60), ends (70) and (72) of the handles (66) and (68) can be grasped and pulled to extend the handles (66) and (68) from the rollers (62) and (64). The handles (66) and (68) are then moved away from each other to reveal the display surface (60).

While in the preferred embodiment the sign (10) is provided with two rollers (14) and (16), another alternative embodiment is shown in FIG. 6, in which the sign (74) is provided with a single roller(76) and a single handle (78) secured to one end of the display surface (80). The other end of the display surface (80) is secured to a supporting rib (82), which may or may not include a pull tab (84).

Although the invention has been described with respect to a preferred embodiment thereof, it is to be understood that it is not to be so limited since changes and modifications can be made therein which are within the full, intended scope of this invention as defined by the appended claims.

What is claimed is:

1. A resilient sign comprising:
(a) a display surface constructed of a resilient material biased toward a curled orientation;
(b) a communication provided on said display surface;
(c) a spool around which is provided said display surface; and
(d) means for unfurling said display surface from said spool sufficient to read said communication and for releasing said display surface to allow said display surface to wind around said spool.

2. The resilient sign of claim 1, wherein said spool comprises:
(a) a roller coupled to said display surface; and
(b) a handle journaled to said roller.

3. The resilient sign of claim 2, wherein said unfurling means comprises:
(a) a supplemental roller; and
(b) a supplemental handle coupled to said roller.

4. The resilient sign of claim 3, wherein the resilient sign is less than five hundred grams.

5. The resilient sign of claim 4, wherein the display surface has no dimension greater than two meters.

6. The resilient sign of claim 5, wherein said display surface has a first side and a second side, wherein said communication is provided on said first side of said display surface and further comprising a supplemental communication provided on said second side of said display surface.

7. The resilient sign of claim 6, wherein said display surface is Mylar®.

8. The resilient sign of claim 1, wherein said spool is provided with a first end and a second end, and further comprising a handle journaled to said first end of said spool and said second end of said spool.

9. The resilient sign of claim 8, wherein said unfurling means comprises a supplemental spool coupled to said display surface.

10. The resilient sign of claim 9, wherein said supplemental spool is provided with a first end and a second end, and flurther comprising a supplemental handle journaled to said first end of said supplemental spool and said second end of said supplemental spool.

11. The resilient sign of claim 10, wherein said unfurling means comprises:
(a) a supplemental roller; and
(b) a supplemental handle coupled to said roller.

12. The resilient sign of claim 11, wherein the display surface has no dimension greater than two meters.

13. The resilient sign of claim 12, wherein said display surface has a first side and a second side, wherein said communication is provided on said first side of said display surface and further comprising a supplemental communication provided on said second side of said display surface.

14. A portable sign comprising:
(a) a spool;
(b) a first handle journaled to said spool;
(c) a display surface coupled to said spool, wherein said display surface is biased toward curling around said spool;
(d) a communication provided on said display surface; and
(e) a second handle operably coupled to said display surface.

15. The portable sign of claim 14, farther comprising a supplemental spool coupled to said display surface, wherein said second handle is journaled to said supplemental spool.

16. The portable sign of claim 15, wherein said display surface is biased toward curling around said supplemental spool.

17. The portable sign of claim 16, wherein said display surface has a first side and a second side, wherein said communication is provided on said first side of said display surface, and further comprising a supplemental communication provided on said second side of said display surface, wherein said second communication is upside-down relative to said first communication.

18. A portable sign comprising:
(a) a first spool;
(b) a first handle journaled to said first spool;
(c) a second spool;
(d) a second handle journaled to said second spool;
(e) a display surface having a first end and a second end;
(f) wherein said first end of said display surface is coupled to said first spool in a manner which biases said first end of said display toward curling around said first spool;
(g) wherein said second end of said display surface is coupled to said second spool in a manner which biases said second end of said display surface toward curling around said second spool; and
(h) a communication provided on said display surface.

19. The portable sign of claim 18, wherein said first spool is provided with a first end and a second end and wherein said first handle is journaled to said first end of said first spool and is journaled to said second end of said first spool, and wherein said second handle is journaled to said first end of said second spool and is journaled to said second end of said second spool.

20. The portable sign of claim 19, wherein said portable sign is less than five hundred grams and wherein no dimension of said display surface is greater than two meters.
